(19) United States
(12) Patent Application Publication
(10) Pub. No.: US 2022/0339814 A1
(43) Pub. Date: Oct. 27, 2022

(54) Portable Pump Systems, Chainsaw Accessories, and Chainsaw Pump Accessory Kits

(71) Applicant: Trigger Point Innovations, LLC, Post Falls, ID (US)

(72) Inventors: Blake Catlin Lindsay, Post Falls, ID (US); Dillon Michael Glover, Moscow, ID (US)

(21) Appl. No.: 17/397,856

(22) Filed: Aug. 9, 2021

Related U.S. Application Data
(63) Continuation-in-part of application No. 16/563,290, filed on Sep. 6, 2019, now Pat. No. 11,090,832.
(60) Provisional application No. 62/727,700, filed on Sep. 6, 2018.

(51) Int. Cl. B27B 17/00; F04D 13/02; F04D 1/00

(52) U.S. Cl. CPC B27B 17/0016; F04D 13/02; F04D 1/00; A62C 25/005

(57) ABSTRACT

Short chainsaw bar assemblies, methods for using a chainsaw motor to operate an accessory, chainsaw drive chain cooling assemblies, methods for cooling a chainsaw drive, chainsaw motor drive adapter assemblies, methods for powering a belt drive from a chainsaw, and chainsaw and accessory assemblies are provided.

### CROSS REFERENCE TO RELATED APPLICATION

This application is a continuation-in-part of U.S. patent application Ser. No. 16/563,290 filed Sep. 6, 2019, entitled “Portable Pump Systems, Chainsaw Accessories, and Chainsaw Pump Accessory Kits”, which claims priority to and the benefit of U.S. Provisional Patent Application Ser. No. 62/727,700 filed Sep. 6, 2018, entitled “Portable Pump Systems, Chainsaw Accessories, and Chainsaw Pump Accessory Kits”, the entirety of each of which is incorporated by reference herein.

### TECHNICAL FIELD

Fire fighters, particularly fire fighters that fight forest fires, can find themselves surrounded by water, but without a way to convey the water to the source of the fire. Often these brave souls have hiked miles into the wilderness supplied only with what they can carry. What they can carry typically includes a chainsaw, but does not include a water pump. The present disclosure provides portable pump systems, chainsaw accessories, and chainsaw pump accessory kits that can be used by those that fight forest fires, for example.

### BACKGROUND

Water pumps and chainsaws are two very important tools for combatting wildfires. They are also extremely heavy for firefighters to carry, especially when walking for miles into and around massive fires. The energy of these brave public servants is probably the most valuable tool in combatting large, destructive fires. Thus, with all of the equipment that a firefighter already has to have to do his or her job, efficiency and reduction of bulky equipment are paramount. The current disclosure helps the firefighter by providing a centrifugal water pump that can be attached to the bar of a chainsaw, eliminating the necessity of carrying excessive gear, such as different fuel for different motors, extra oil, or an attached engine. The increased efficiency from the present disclosure can be beneficial for home defense, irrigation, or other uses, as well as fighting fires.

### SUMMARY

A short bar sprocket and pump assembly as well as short bar sprocket and pump and chainsaw motor assemblies are provided.

A method for using a chainsaw motor to operate an accessory is provided, the method comprising: providing a chainsaw motor having a chainsaw bar attached thereto; removing the chainsaw bar from the chainsaw motor; and coupling an accessary bar to the chainsaw motor, wherein the accessory bar defines one length between the motor and accessory that is less than another length of the chainsaw bar between the motor and the bar tip.

A chainsaw drive chain cooling assembly is provided, the assembly comprising: a chainsaw motor operably coupled via a drive chain to a pump assembly; and one or more conduits extending from the pump assembly to operably align with the drive chain and distribute fluid from the pump assembly.

A method for cooling a chainsaw drive is provided, the method comprising distributing fluid from a pump assembly to the chainsaw drive chain, wherein the pump assembly is operably coupled to the chainsaw motor.

A chainsaw motor drive adapter assembly is provided, the assembly comprising: at least a pair of separable complimentary portions configured to be coupled to one another and encompass a chainsaw motor drive; one or more extensions from one or more of the portions extending inwardly from an interior edge of at least one of the portions; and wherein the one or more extensions is configured to operably engage a recess of the chainsaw motor drive.

A method for powering a belt drive from a chainsaw is provided, the method comprising: providing a chainsaw motor having a chainsaw motor drive; encompassing the motor drive to engage recesses of the drive with an adapter; and engaging the adapter with a belt drive.

A chainsaw and accessory assembly is provided, the assembly comprising a chainsaw motor operably coupled to a chainsaw accessory by a belt drive.

### DRAWINGS

Embodiments of the disclosure are described below with reference to the following accompanying drawings.

FIG. 1A depicts two perspective views of an embodiment of the disclosure.

FIG. 1B depicts two perspective views of a different embodiment of the present disclosure.

FIG. 2 is a perspective view of an embodiment of the disclosure.

FIG. 3 is a perspective view of a different embodiment of the disclosure.

FIG. 4 is a deconstructed view of the components of a water pump connection system, according to an embodiment of the disclosure.

FIG. 5 is a detailed view of the connection between a chainsaw bar and driving rings, according to one embodiment of the disclosure.

FIG. 6 is a deconstructed view of operable connective pieces, according to one embodiment of the disclosure.

FIG. 7 is a detailed view of operable connective pieces, according to one embodiment of the disclosure.

FIG. 8A is a detailed view of the safety spike system, according to an embodiment of the disclosure.

FIG. 8B is a detailed view of the safety spike system, according to an embodiment of the disclosure.

FIG. 8C is a detailed view of the safety spike system, according to an embodiment of the disclosure.

FIG. 9 is a perspective view of an embodiment of the disclosure.

FIG. 10 is a detailed view of the embodiment of the disclosure shown in FIG. 9.

FIG. 11A is a detailed view of a portion of a water pump connection system, according to an embodiment of the disclosure.

FIG. 11B is a detailed view of a portion of a water pump connection system, according to an embodiment of the disclosure.

FIG. 12 is a detailed view of a throttle and throttle lock device of a water pump system, according to an embodiment of the disclosure.

FIG. 13 is a perspective view of a water pump system packaged for mobility, according to an embodiment of the disclosure.

FIGS. 14A-C depict a series of stages of the assemblies of the present disclosure.

FIG. 15 is a depiction of a completed pump assembly according to an embodiment of the present disclosure.

FIG. 16 is an uncoupled chainsaw according to an embodiment of the present disclosure.

FIG. 17 is a partially assembled assembly according to an embodiment of the disclosure.

FIG. 18 is a more detailed view of the assembly of FIG. 17 according to an embodiment of the disclosure.

FIG. 19 is a more detailed view of a completed assembly according to an embodiment of the disclosure.

FIG. 20 is yet a more detailed view of a portion of the assembly of the present disclosure.

FIG. 21 is a detailed view of a support assembly according to an embodiment of the disclosure.

FIG. 22 is an example of a chainsaw motor and adapter assembly according to an embodiment of the disclosure.

FIG. 23 is an example of a chainsaw motor adapter and accessory according to an embodiment of the disclosure.

FIG. 24 is a more detailed view of a chainsaw motor adapter according to an embodiment of the disclosure.

FIG. 25 is an example of a chainsaw coupling interface according to an embodiment of the disclosure.

FIG. 26 is a partial configuration of a chainsaw motor coupling interface according to an embodiment of the disclosure.

FIG. 27 is the coupling interface of FIG. 26 in a more partially constructed configuration according to an embodiment of the disclosure.

FIG. 28 is the interface of FIG. 27 in an even more partially constructed configuration according to an embodiment of the disclosure.

FIG. 29 is a completely constructed interface of the previous figure according to an embodiment of the disclosure.

FIG. 30 is an exploded view of an interface according to an embodiment of the disclosure.

FIG. 31 is a view of a portion of the interface according to an embodiment of the disclosure.

FIG. 32 is a view of a portion of a drive shaft of the interface according to an embodiment of the disclosure.

### DESCRIPTION

This disclosure is submitted in furtherance of the constitutional purposes of the U.S. Patent Laws “to promote the progress of science and useful arts” (Article 1, Section 8).

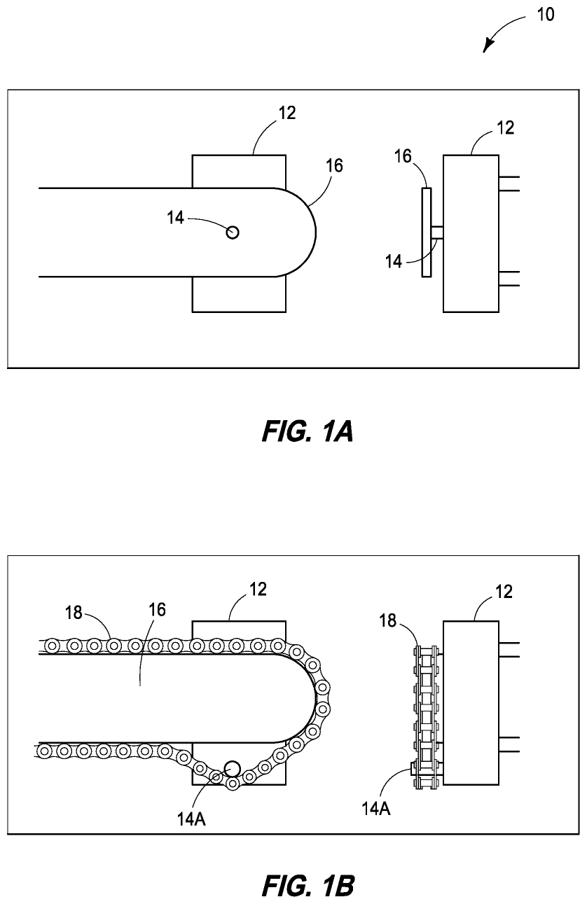

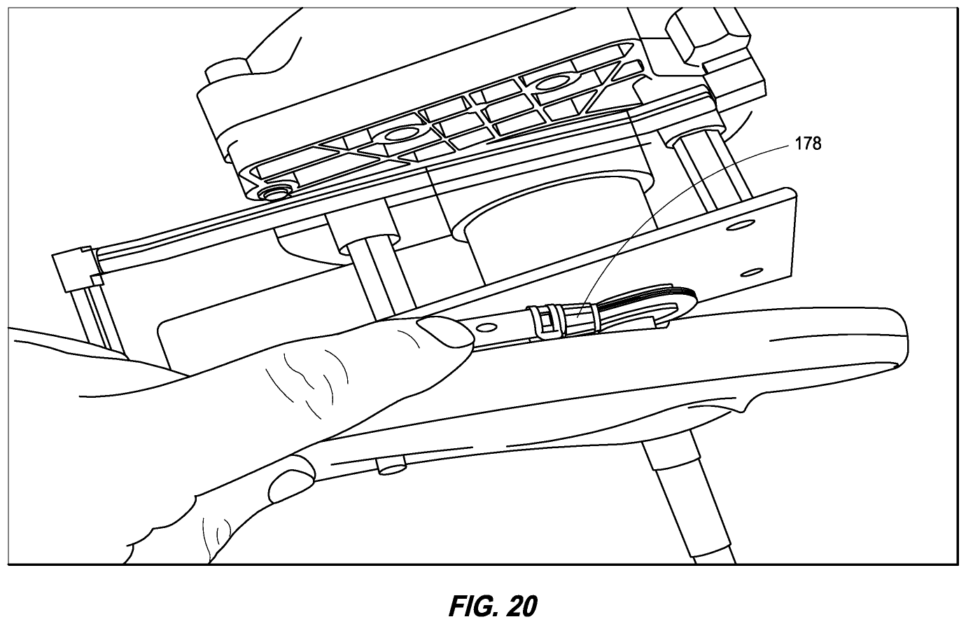

Portable pump systems, chainsaw accessories, and chainsaw pump accessory kits are described with reference to FIGS. 1A through 32.

Referring to FIGS. 1A and 1B, embodiments of a water pump system 10 are shown. FIG. 1A depicts a perspective view of a chainsaw bar 16 coupled to a water pump head 12 by a coupling device 14. FIG. 1A also depicts this configuration from a perspective view from the end of the chainsaw bar 16, showing the same components, a water pump head 12 and a coupling device 14. FIG. 1B depicts two perspective views of a different embodiment of the disclosure, wherein the coupling device 14A sits at a different position on the water head pump 12, which can be lower. In this embodiment, there is a chain 18 on the chainsaw bar 16. The chain 18 can be connected to the coupling device 14A.

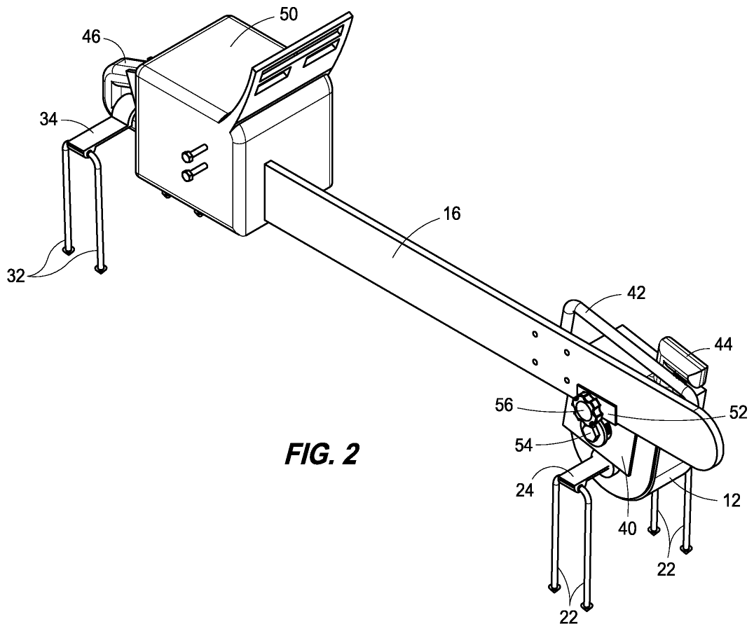

Referring next to FIG. 2, a centrifugal water pump system is shown with a chainsaw motor 50 connected to a chainsaw bar 16 and a throttle 46. The chainsaw bar is coupled to a water pump head 12 having a handle 42 and a discharge pipe 44. The chainsaw bar 16 is coupled to the water pump head 12 by a mounting bracket 40 and a mounting bracket bolt 54, and the chainsaw bar is stabilized in this position by a chainsaw bar stabilizer 52 and a chainsaw stabilizer bolt 56. FIG. 2 also depicts water pump safety spikes 22 positioned below the water pump head 12 and secured to the water pump head 12 by a water pump safety spike mount 24. The chainsaw motor 50 is also coupled to chainsaw head safety spikes 32 by a chainsaw head safety spike mount 34.

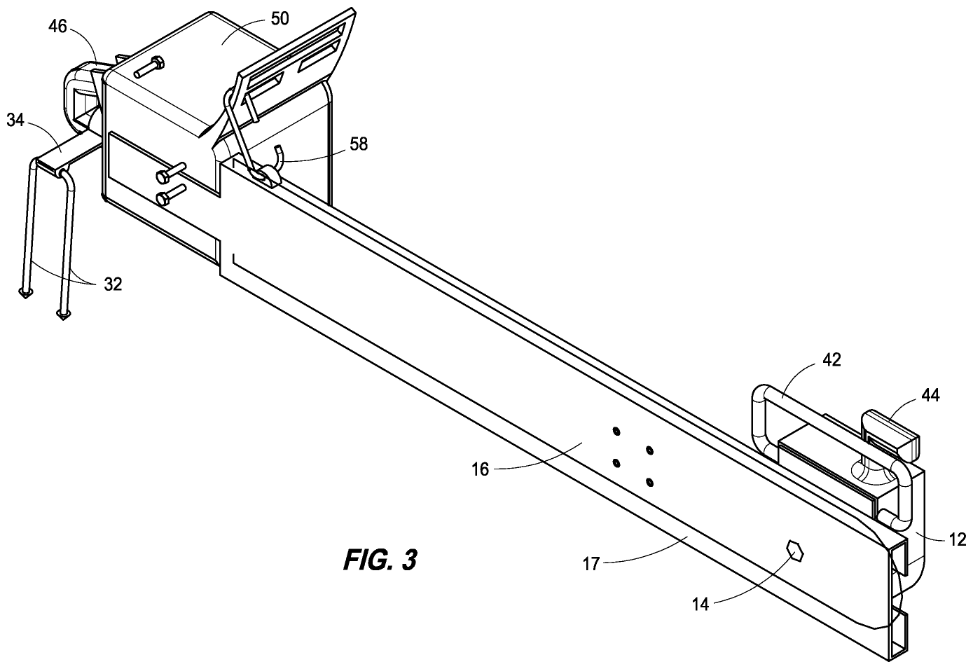

Referring next to FIG. 3, a different configuration of a centrifugal water pump system is shown. In this configuration, a chainsaw bar 16 is surrounded by a chain guard 17. In this configuration, a coupling device 14 fastens the chainsaw bar 16 to a water pump head 12 that has a handle 42 and discharge pipe 44. A chainsaw motor head 50 connects to the chainsaw bar 16. The chainsaw motor head 50 has a throttle 46 and is connected to a chain brake release 58 that fastens to the chain guard 17. FIG. 3 also depicts chainsaw safety spikes 32 coupled to the chainsaw motor 50 by a chainsaw safety spike mount 34.

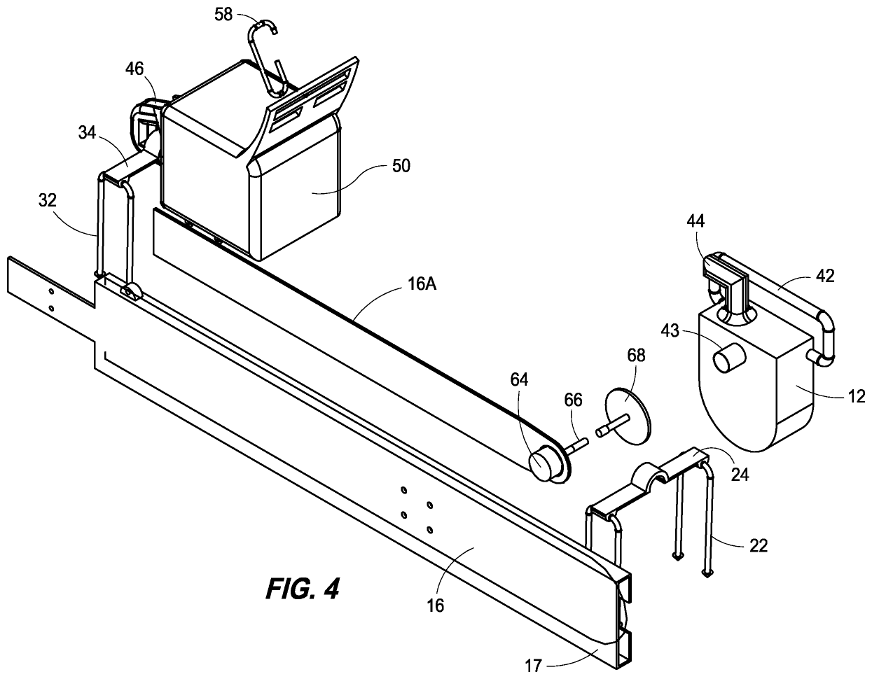

Referring next to FIG. 4, the components of a centrifugal water pump system are shown. A chainsaw motor 50 having a throttle 46 is shown; a chain brake release 58 is shown. The chainsaw motor is coupled to chainsaw head safety spikes 32 by a chainsaw head safety spike mount 34. A chainsaw bar 16 is surrounded by a chain guard 17. A second side of a chainsaw bar 16A is shown, coupled with a female drive ring 64 and drive ring adapter 66 configured to couple with a male drive ring 68. FIG. 4 also depicts a water pump head 12 that has a suction pipe 43 and a discharge pipe 44. FIG. 4 also depicts water pump safety spikes 22 attached to a water pump safety spike mount 24.

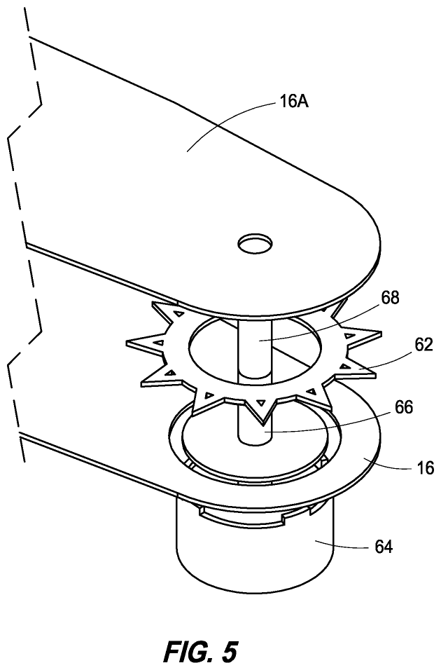

Referring next to FIG. 5, a detailed view of the components of an embodiment of the disclosure is shown. A chainsaw bar 16 is operably coupled with a side of a chainsaw bar 16A by a male drive ring 68 connected to a drive ring adapter 66 and a female drive ring 64. A spurred drive ring gear 62 circles the drive ring adapter 66. The spurred drive ring gear 62 is configured to capture a chainsaw chain.

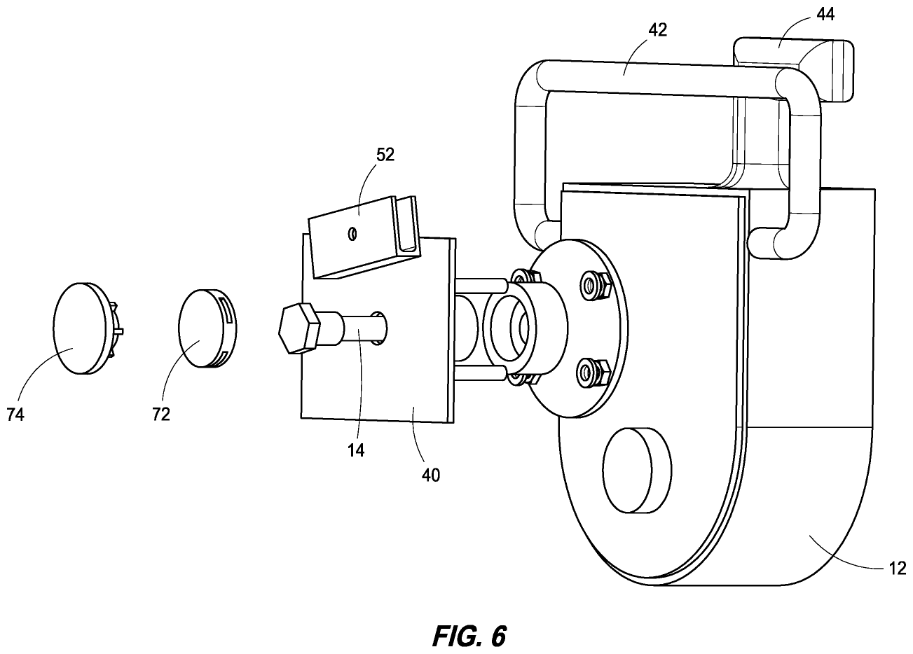

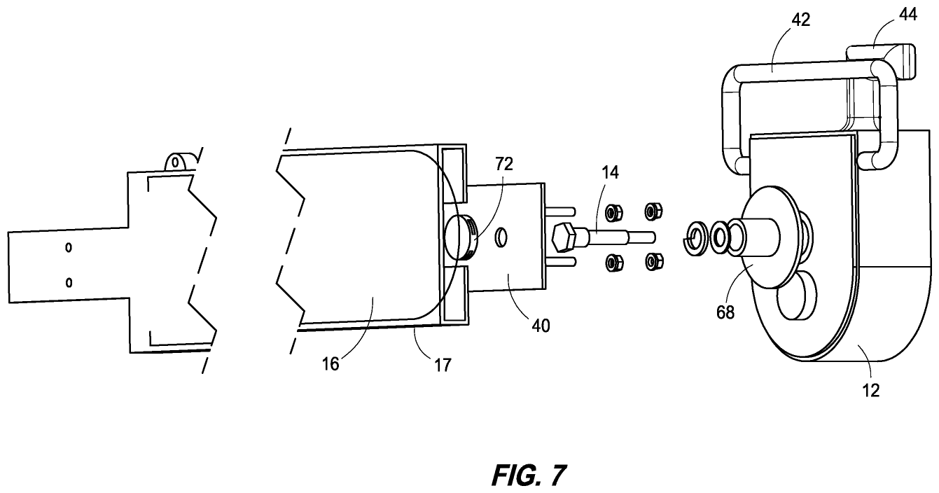

Referring next to FIG. 6, a water pump head 12 with a discharge pipe 44 and a handle 42 is shown. Also shown is a mounting bracket 40 connected to a chainsaw bar stabilizer 52 and a coupling device 14. For adaptation configurations, a drive sprocket 72 and a spline adapter for capturing a chainsaw chain may be utilized as shown. Referring next to FIG. 7, the components of a centrifugal water pump system are shown. A chainsaw bar 16 and a chain guard 17 are shown, as well as a water pump head 12 with a handle 42 and a discharge pipe 44. Connecting the chainsaw bar 16 to the water pump head 12 are the components, a drive sprocket 72, a mounting bracket 40, a coupling device 14, and a male drive ring 68.

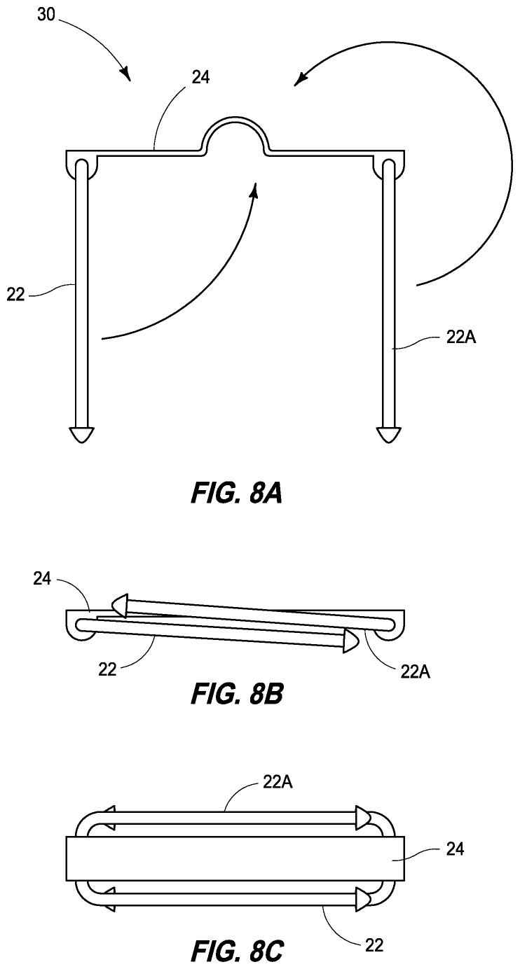

Referring next to FIGS. 8A, 8B, and 8C, configurations of safety spikes 22 and 22A and a safety spike mount 24 are shown. FIG. 8A depicts safety spikes 22 and 22A connected to safety spike mount 24 in operating position, with safety spikes 22 and 22A opened to be parallel with each other and perpendicular to safety spike mount 24. FIG. 8A is configured to be planted into the ground and secure the pump and/or chainsaw motor during operation. FIG. 8B depicts a perspective view of the safety spike configuration collapsed, where each of the safety spikes 22 and 22A rotates in the same angular direction so that safety spike 22 sits essentially flush with the safety spike mount 24, and safety spike 22A sits essentially flush with the safety spike mount 24, but on the opposite side of safety spike mount 24 from safety spike 22, when in the collapsed position. FIG. 8C depicts a perspective of the collapsed safety spikes 22 and 22A on either side of the safety spike mount 24.

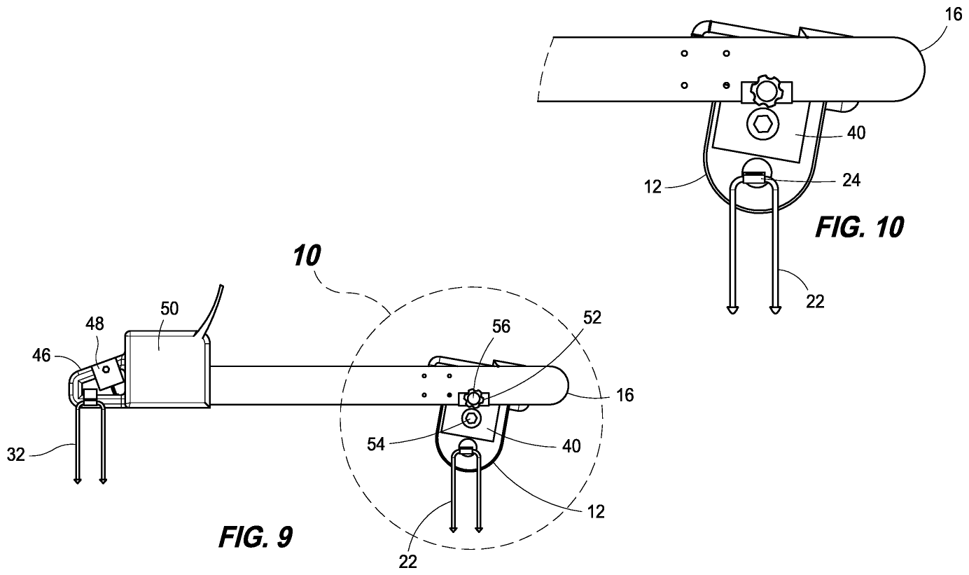

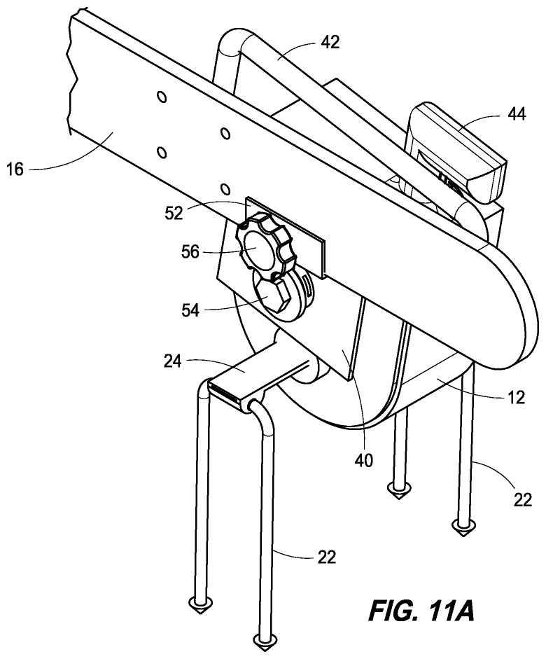

Referring next to FIGS. 9 and 10, a centrifugal water pump system is shown. A chainsaw motor 50 has a throttle 46 coupled to a throttle lock device 48 and is supported by chainsaw head safety spikes 32. Connected to the chainsaw motor 50 is a chainsaw bar 16 which is secured to a chainsaw bar stabilizer 52 by a chainsaw stabilizer bolt 56. Also coupled to the chain guard 17 is a water pump head 12, which is coupled to the chainsaw bar 17 by a mounting bracket 40 and a mounting bracket bolt 54. This end of the water pump system is supported by water pump safety spikes 22, as shown in FIG. 10, a detailed view of FIG. 9. The water pump spikes 22 are connected to the water pump head 12 by a water pump spike mount 24. FIG. 10 also depicts the chainsaw bar 16 coupled to a mounting bracket 40 and water pump head 12.

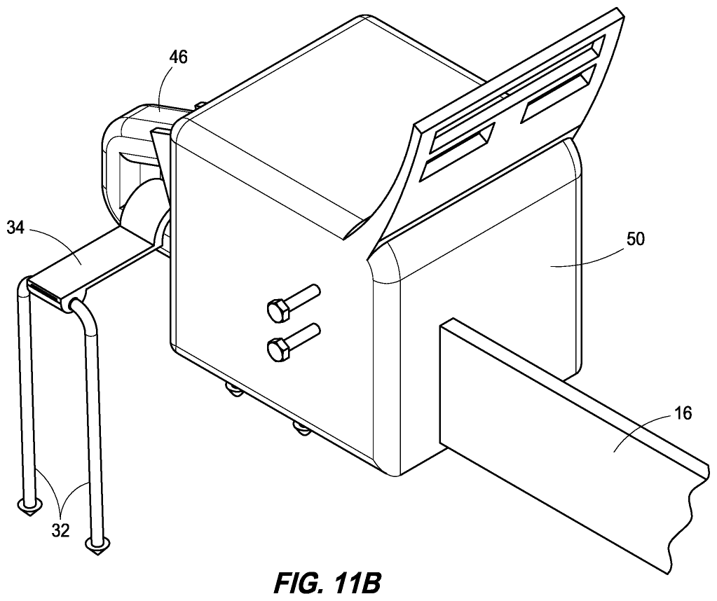

Referring next to FIGS. 11A and 11B, FIG. 11A depicts the water pump head 12 with a handle 42 and a discharge pipe 44. The water pump head 12 is connected to a chainsaw bar 16 by a mounting bracket 40 and a mounting bracket bolt 54. The chainsaw bar 16 is also coupled to a chainsaw bar stabilizer 52 by a chainsaw stabilizer bolt 56. The water pump head 12 is supported in this embodiment by water pump safety spikes 22, which are coupled to the water pump head 12 by a water pump safety spike mount 24. FIG. 11B depicts a detailed view of a chainsaw motor 50 connected to a chainsaw bar 16. The chainsaw motor has a throttle 46 which is coupled to a chainsaw head safety spike mount 34. The chainsaw head safety spike mount 34 is coupled to chainsaw head safety spikes 32, which support the chainsaw motor 50 when planted in the ground during operation.

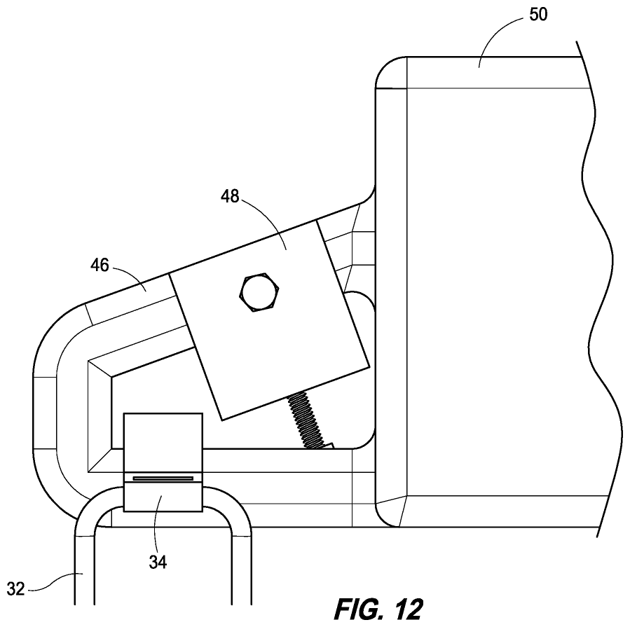

Referring next to FIG. 12, a detailed view of a throttle 46 is shown. The throttle 46 is connected to a chainsaw motor 50. The throttle 46 is coupled to a chainsaw head safety spike mount 34. The chainsaw head safety spike mount 34 is connected to chainsaw head safety spikes 32. The throttle is further coupled to a throttle lock device 48 for hands-free consistent motor operation.

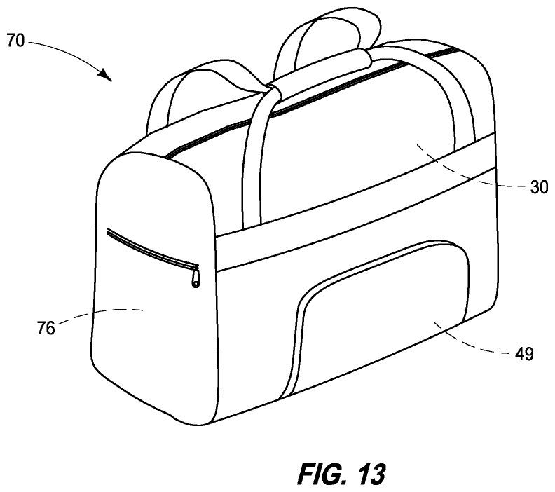

Referring next to FIG. 13, a water pump system 70 is shown in a portable kit configuration. In the system 70, a safety spike system 30 can be contained, along with a pump head 76 which can contain a water pump head and connective accessories, and throttle control 49 which can contain a throttle control and connective accessories.

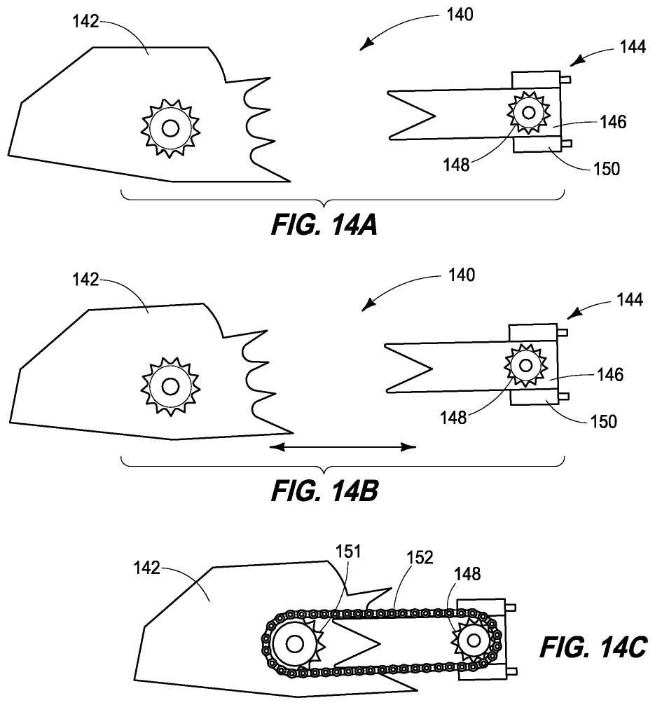

Referring to FIGS. 14A-B, FIG. 14A depicts an assembly 140 that includes a chainsaw motor assembly 142 and a pump bar assembly 144. In accordance with an example implementation, the chainsaw motor assembly can be a commercially available chainsaw motor, and in this depiction, a Stihl® chainsaw is utilized. In accordance with example implementations, the pump bar assembly 144 can include a bar 146. Bar 146 can be configured to couple to assembly 142, however substantially insufficient in length to operate as a chainsaw bar. Bar 146 can include perimeter recesses configured to receive a drive chain adapted as a power chain without cutting teeth. Chain 152 can include drivers configured to be engaged by sprockets. Assembly 144 can include this short bar 146 as well as a sprocket 148 and a pump operatively coupled to pump 150 operatively coupled to sprocket 148. In accordance with example implementations, a short chain 152 with no cutting teeth, for example, can be engaged by a motor sprocket 151 of chainsaw motor 142 and sprocket 148 of assembly 144. Coupling can be facilitated with existing bolts of motor 142 upon the coupling of bar 146 with chainsaw motor 142 as shown in FIG. 14C.

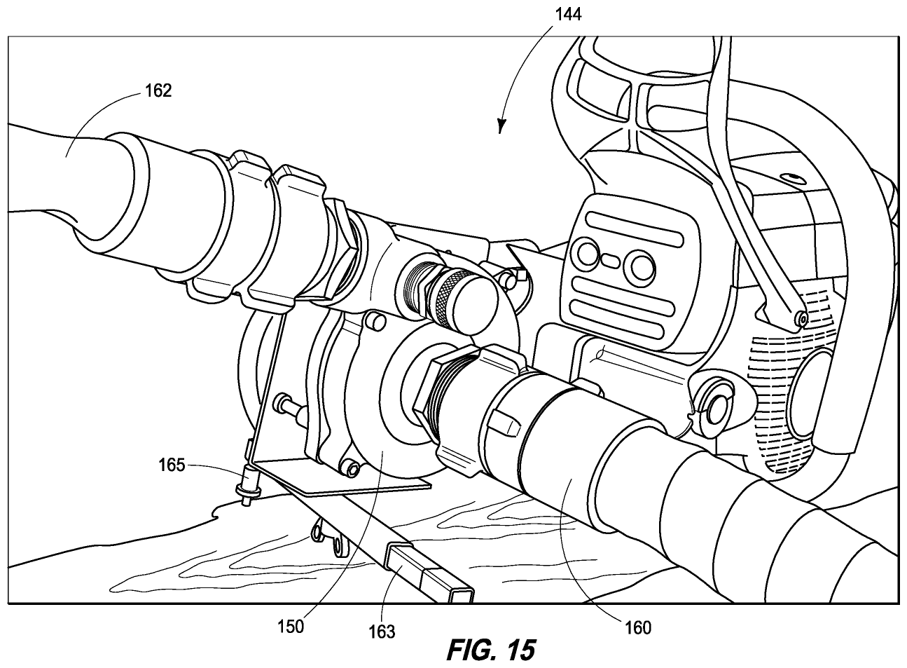

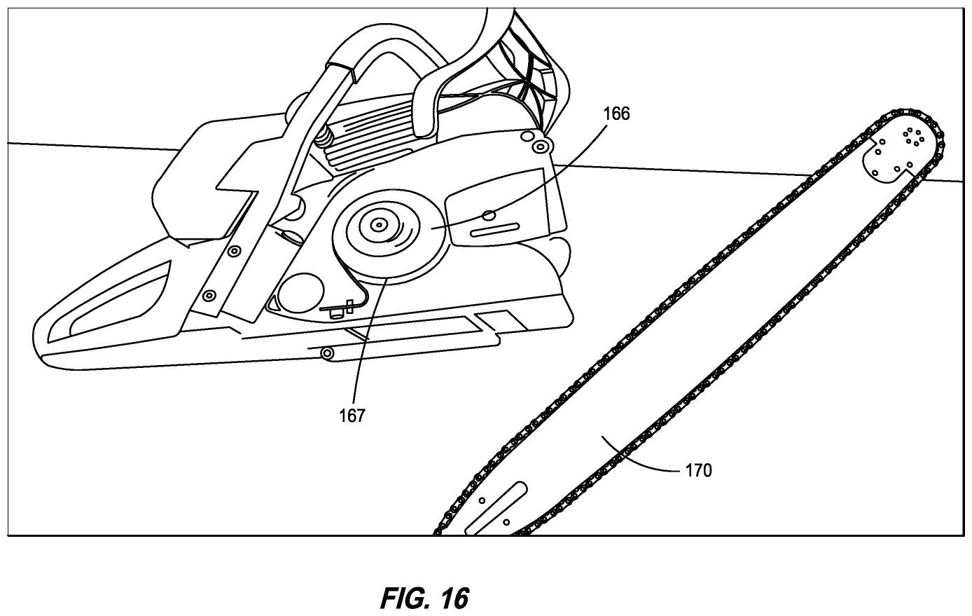

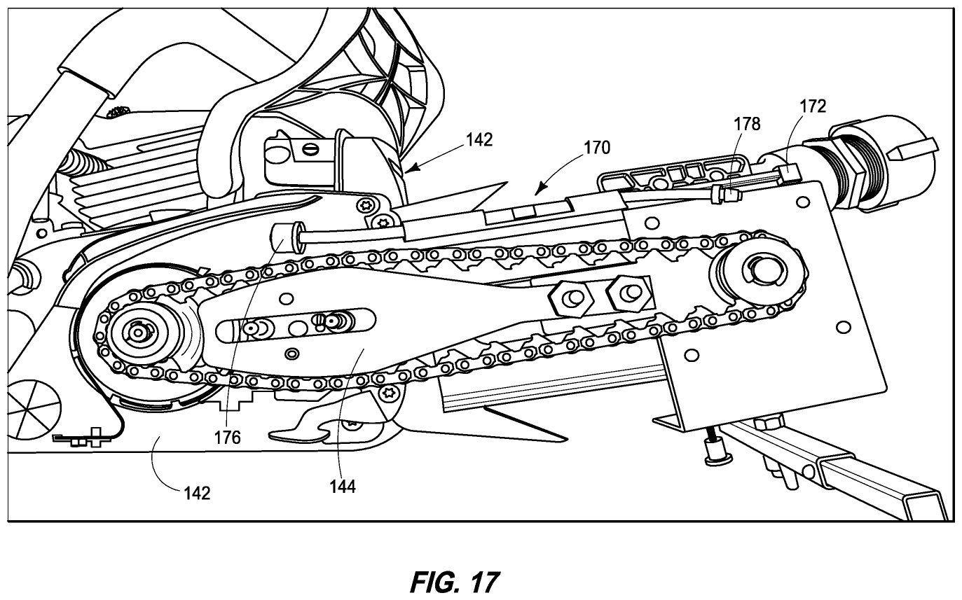

Referring next to FIG. 15, a completed and assembled chainsaw with pump bar assembly 144 is shown with pump 150 coupled to hose intake 160 (suction) and outtake 162 (discharge) portions. Referring next to FIG. 16, in accordance with assembly instructions, a chainsaw bar 170 can be removed from a chainsaw motor 142, and referring to FIG. 17, a short bar assembly 144 can be coupled to the chainsaw motor 142.

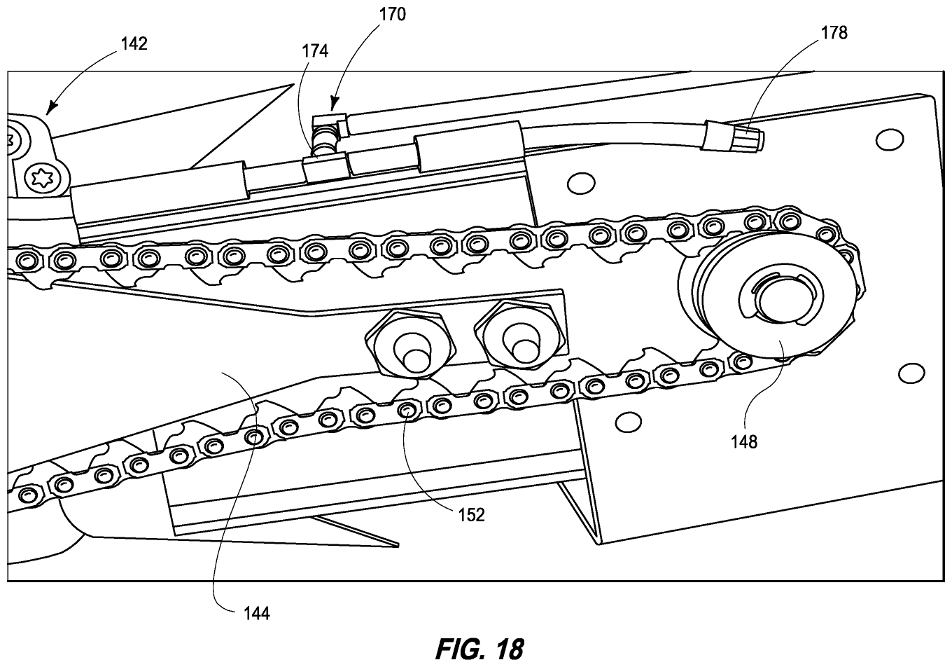

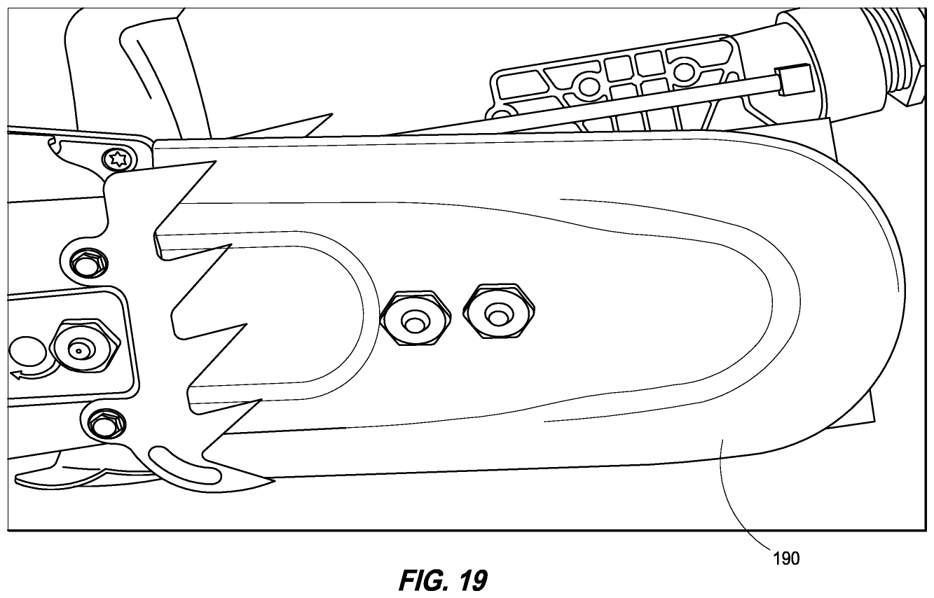

Referring next to FIG. 18, a more detailed view shows a cutterless chain 152 that includes inverted drivers but no exterior cutting teeth about the chain used to propel a sprocket 148 of the bar pump assembly 144 when being engaged by sprocket 151. Referring to FIG. 19, a cover 190 can be placed over a portion of the short bar sprocket pump assembly 144. In accordance with example implementations and with reference to FIGS. 17-20, a more detailed view shows the engagement of a cooling system 170 which provides coolant, such as water, to both sprocket 151 and 148. In accordance with example implementations, system 170 can engage pump 150 at coupler 172. From coupler 172 fluid can be provided to a T-junction 174. From junction 174, fluid can be provided to nozzles 176 and 178 respectively. Both nozzles can be placed proximate the respective sprockets. The nozzles may be of an adjustable or fixed flow rate.

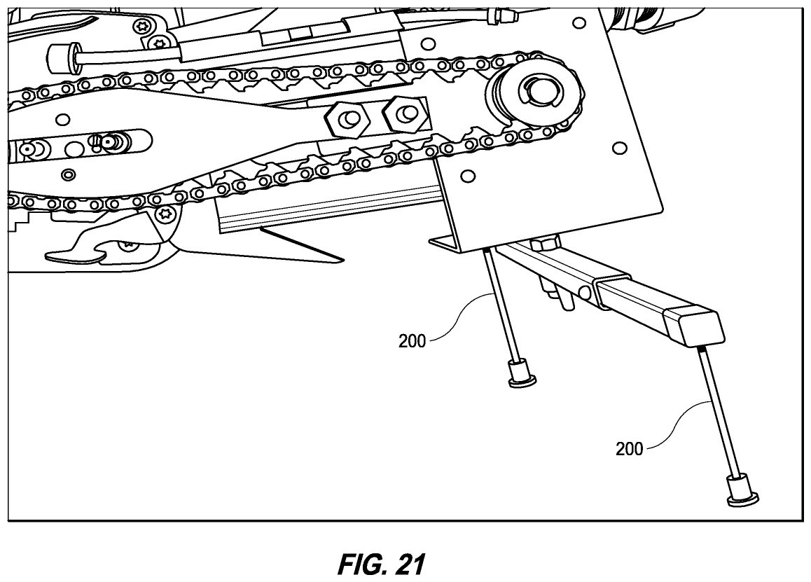

Referring next to FIG. 21, the support assembly can include extension legs 200 that may be utilized as the support landscape dictates.

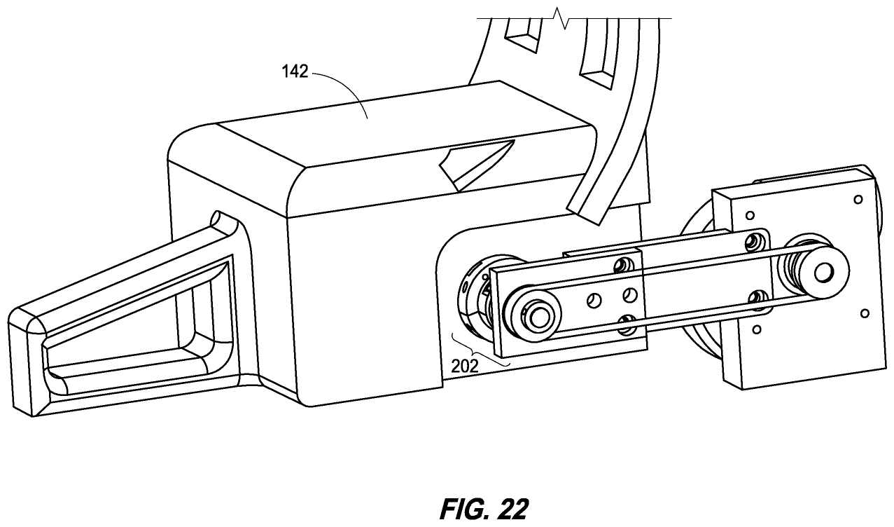

In accordance with example implementations and with reference to FIGS. 22-32, the assemblies of the present disclosure can be utilized to pump clean, fresh non-potable water.

In accordance with example implementations, typical chainsaws include items that can be removed/modified in accordance with the present disclosure. For example, the clutch cover, bar and chain from powerhead of chainsaw can be removed and set aside. Bar oil can be drained from powerhead back into bar oil jug and/or eco-friendly bar oil can be used.

A bar of a bar/sprocket/pump assembly described herein can be attached to the chainsaw powerhead. A cutterless chain can be engaged with the sprocket and powerhead sprocket. The clutch cover can be replaced and bar nuts can be tightened finger tight, and the safety guard can be installed onto front bar studs and guard nuts tightened. The rear of safety guard can be inside of the dogs on the powerhead.

The completed assembly can be placed on a relatively level surface. A stability platform can be expanded and the feet adjusted for maximum stability. For added stability in sandy or loose soil, the provided spikes can be screwed on to feet and the spikes pushed into the ground (optional).

A discharge hose can be attached to the discharge port and the suction hose filled with water and attached to the suction port.

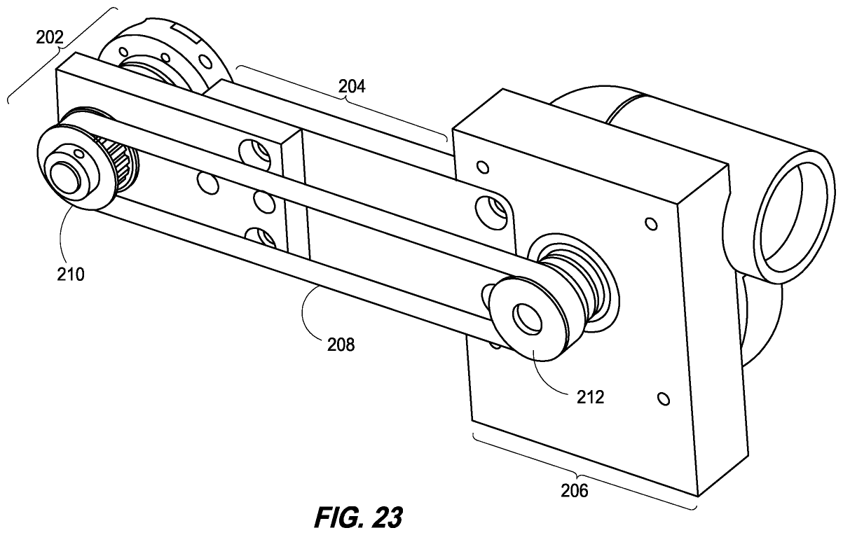

Referring next to FIG. 22, a chainsaw motor 142 is shown coupled to drive wheel (powerhead) coupling assembly 202. Drive wheel coupling assembly 202 can be utilized to transfer power from chainsaw motor 142 to an accessory operatively coupled with drive wheel coupling assembly 202. Drive wheel coupling assembly 202 is further shown in the context of the accessory in FIG. 23. Accordingly, drive wheel coupling assembly 202 is operatively engaged with drive wheel 210 along an arm 204 via belt 208 to an accessory wheel 212 that is operatively associated with an accessory assembly 206. The accessory mentioned here is a pump. However, other driven accessories can be utilized as well. Additionally, arm 204 can be in multiple components as shown, or a single component. Drive wheel 210 can be a belt drive wheel which may include a toothed belt, for example, and/or a smooth belt. In accordance with example implementations, the belt 208 can be a chain that does not include cutting heads but does include dive links and accordingly wheels 210 and 212 are configured to receive the drive links in an operable fashion. In accordance with additional implementations, accessory wheel 212 can be operatively engaged with accessory assembly 206 which can include a bracket and the accessory. The accessory can be a pump as discussed, or additional accessories, including power generators, if desirable.

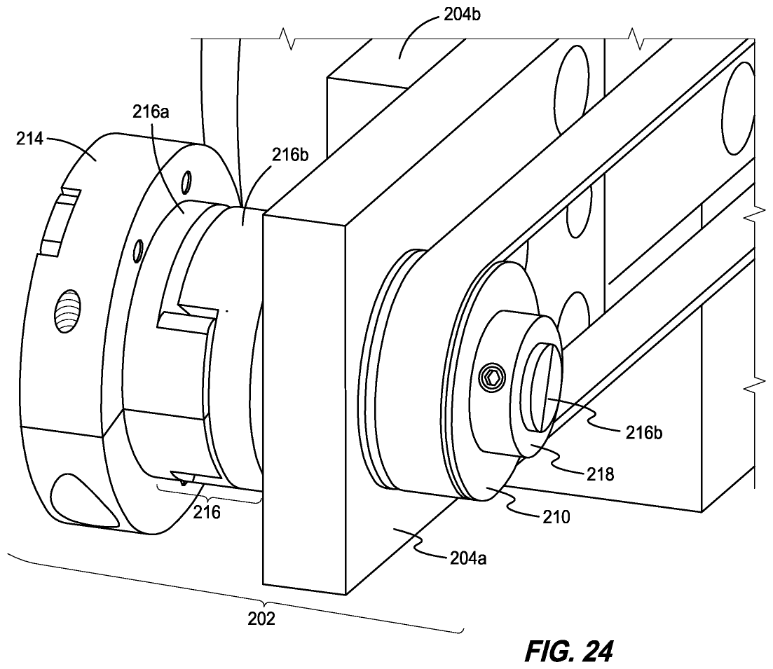

In accordance with example implementations and with reference to FIG. 24, a more detailed view of a portion (drive head) of the accessory assembly is shown, including one segment of arm 204b coupled to another segment of arm 204a, as well as a coupling interface 216a and coupling interface 216b. Coupling interface 216a can be rigidly affixed to a portion of drive wheel assembly adapter 214 which is part of the drive wheel coupling assembly 202. In accordance with example implementations, coupling interface portion 216a can be operatively produced to releasably engage a drive portion 216b of coupling interface 216, thereby allowing for the quick slip-on and slip-off adaption of the accessory arm and drive assembly to the coupling interface of the 216a coupling interface.

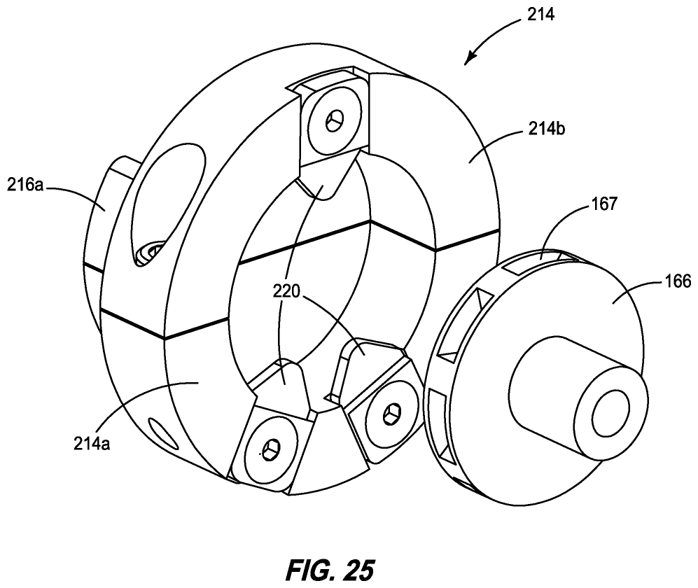

Referring next to FIG. 25, a more detailed view of the coupling interface 216 is shown, and as shown, coupling interface 216 can include at least two portions 214a and 214b. In accordance with example implementations, these portions can be disconnected and then reconnected to embrace the chainsaw drive 166 that includes recesses 167. In accordance with example implementations, chainsaw drive 166 can be configured to drive a chainsaw cutting chain which typically includes appendages to be received by the drive recesses 167, thereby providing the drive of the chain from the chainsaw motor. In accordance with example implementations, teeth 220 can be provided as part of the coupling interface to engage recesses 167 when the coupling interface is affixed about the chainsaw motor drive 166.

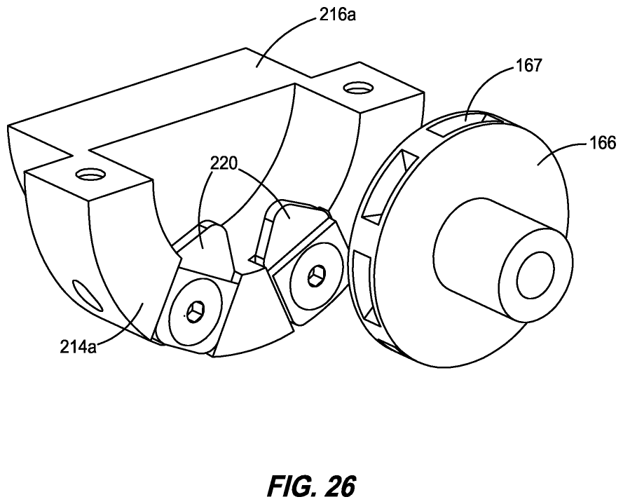

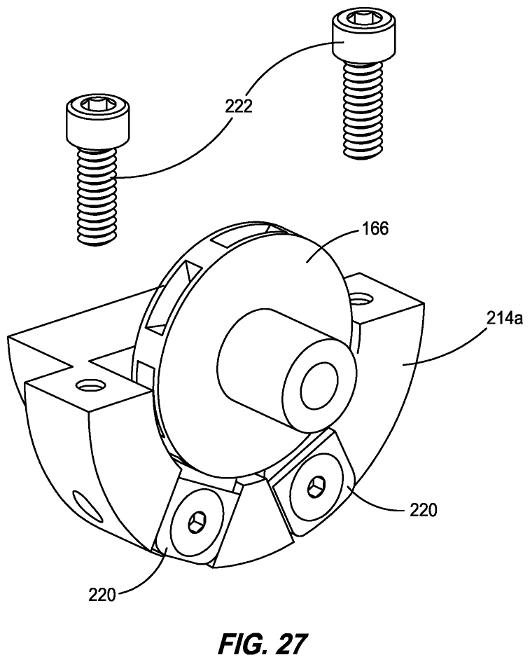

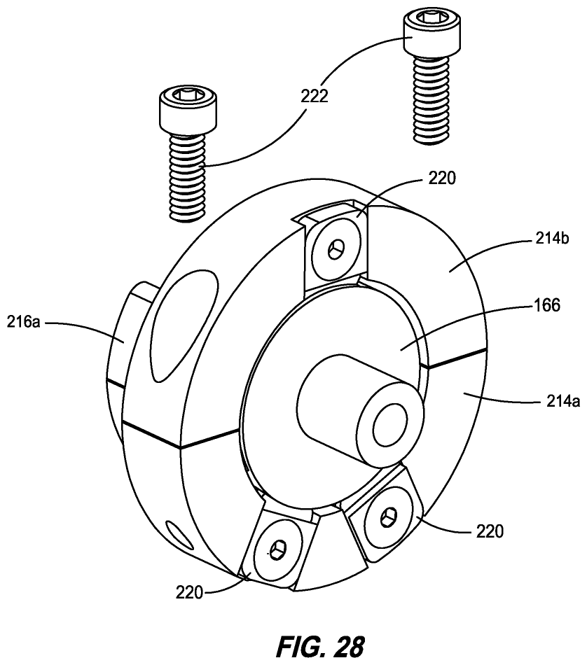

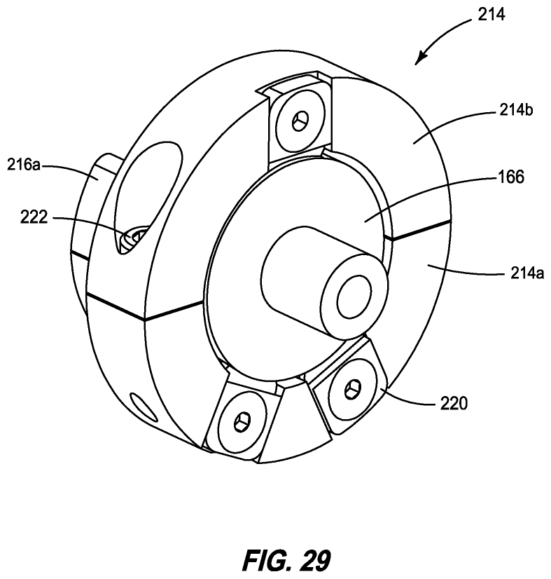

Referring to FIG. 26, portion 214 of the drive wheel adapter is shown that includes teeth 220 affixed thereto. In accordance with example implementations, this portion 214 can embrace the chainsaw motor drive 166 as shown in FIG. 27. As shown in FIG. 28, fasteners 222 can be utilized to provide the other portion of the portion 214b of the drive wheel adapter assembly to embrace the chainsaw motor drive 166 therein. As shown, teeth 220 can embrace and be received within the recesses of the chainsaw motor drive, and fasteners 222 can be utilized to affix portions 214b and 214a about same. Referring next to FIG. 29, the fasteners 222 are engaged to engage portions 214a and 214b to embrace the chainsaw motor drive 166.

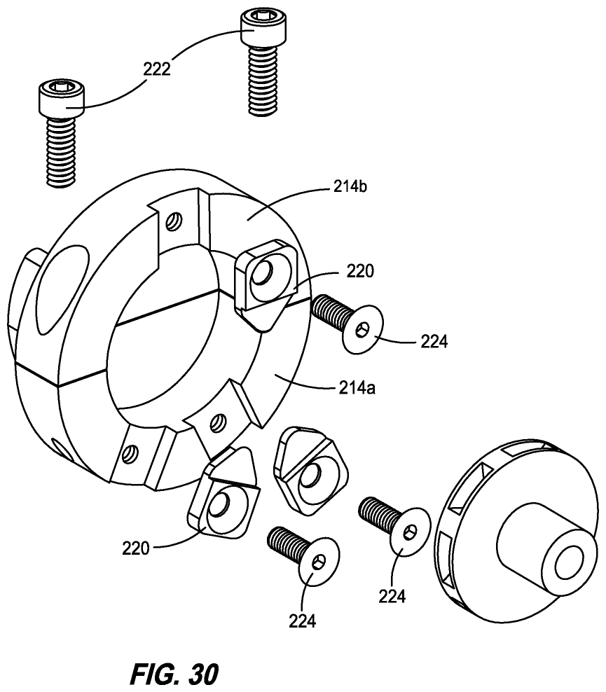

Referring to FIG. 30, an exploded view of the components of the adapter assembly is shown that includes fasteners 224 to affix teeth 220 to portions 214b and 214a as shown.

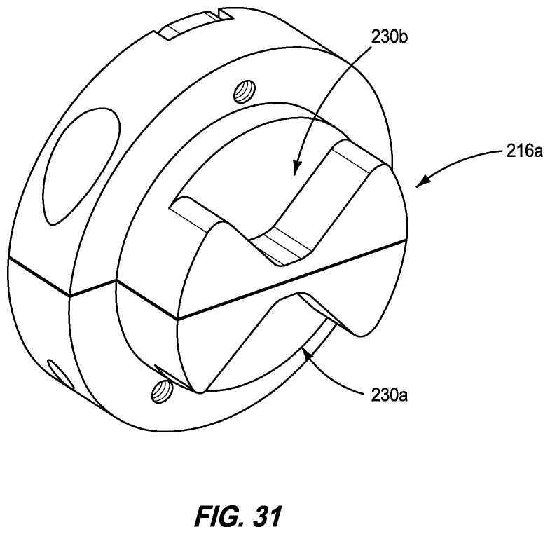

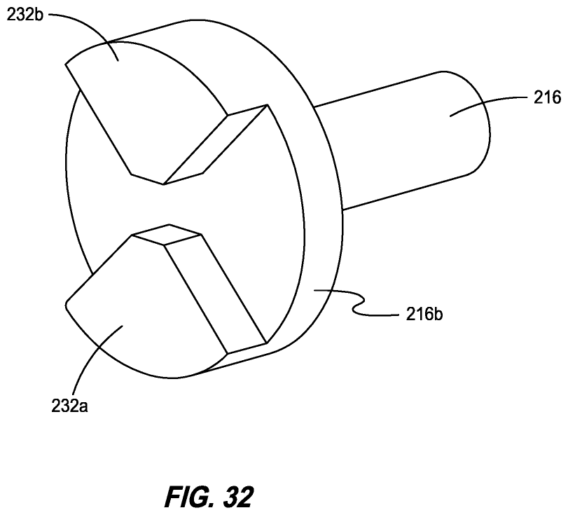

Referring next to FIG. 31, on the opposing side from the embracing side of adapter 214 is the drive side 216a as shown. Portions 214a and 214b can have complimentary portions 230a and 230b that include recesses therein configured to receive complimentary appendages 232b and 232a of drive 216 as shown in FIG. 32. In accordance with example implementations, this assembly can be configured to provide power to an accessory along the arm shown and provide additional usage of a chainsaw motor in the field by an operator.

In compliance with the statute, embodiments of the disclosure have been described in language more or less specific as to structural and methodical features. It is to be understood, however, that the entire disclosure is not limited to the specific features and/or embodiments shown and/or described, since the disclosed embodiments comprise forms of putting the disclosure into effect. The disclosure is, therefore, claimed in any of its forms or modifications within the proper scope of the appended claims appropriately interpreted in accordance with the doctrine of equivalents.

1. A method for using a chainsaw motor to operate an accessory, the method comprising:
providing a chainsaw motor having a chainsaw bar attached thereto;
removing the chainsaw bar from the chainsaw motor; and
coupling an accessary bar to the chainsaw motor, wherein the accessory bar defines one length between the motor and accessory that is less than another length of the chainsaw bar between the motor and the bar tip.

2. The method of claim 1 wherein the chainsaw motor includes a chainsaw motor drive, the chainsaw motor drive defining recesses configured to receive teeth of a chainsaw cutting chain.

3. The method of claim 2 wherein the accessory bar includes a channel configured to receive the teeth of the chainsaw cutting chain.

4. The method of claim 1 further comprising providing a chainsaw chain having length operable to engage the accessory bar.

5. The method of claim 1 further comprising providing an accessory support assembly.

6. The method of claim 5 wherein the chainsaw motor and accessory support assembly form a tripod of support.

7. The method of claim 1 further comprising pumping fluid with the accessory.

8. The method of claim 7 wherein the fluid is water.

9. A chainsaw drive chain cooling assembly comprising:
a chainsaw motor operably coupled via a drive chain to a pump assembly; and
one or more conduits extending from the pump assembly to operably align with the drive chain and distribute fluid from the pump assembly.

10. The assembly of claim 9 further comprising at least one conduit terminating in at least one nozzle.

11. The assembly of claim 10 wherein the one nozzle is operatively associated with a pump assembly drive.

12. The assembly of claim 10 further comprising another conduit terminating in another nozzle.

13. The assembly of claim 12 wherein the other nozzle is operatively associated with a chainsaw motor chain drive.

14. The assembly of claim 9 further comprising a sheath about at least portion of the chain drive and enclosing at least a portion of the one or more conduits.

15. The assembly of claim 14 wherein the one or more conduits terminate in one or more nozzles, at least one of the nozzles being enclosed by the sheath.

16. A method for cooling a chainsaw drive, the method comprising distributing fluid from a pump assembly to the chainsaw drive chain, wherein the pump assembly is operably coupled to the chainsaw motor.

17. The method of claim 16 further comprising distributing fluid to a pump drive of the pump assembly.

18. The method of claim 16 further comprising distributing fluid to a chain drive of the chainsaw motor.

19. The method of claim 16 further comprising distributing fluid to both a pump drive of the pump assembly and a chain drive of the chainsaw motor.

20. The method of claim 16 further comprising distributing water from the pump assembly.

21. The method of claim 16 further comprising retaining the fluid proximate the chain drive using a sheath.

22. A chainsaw motor drive adapter assembly comprising:
at least a pair of separable complimentary portions configured to be coupled to one another and encompass a chainsaw motor drive;
one or more extensions from one or more of the portions extending inwardly from an interior edge of at least one of the portions; and
wherein the one or more extensions is configured to operably engage a recess of the chainsaw motor drive.

23. The assembly of claim 22 further comprising members extending from each of the complimentary portions and configured to form one interface when the portions are coupled.

24. The assembly of claim 23 further comprising a belt drive extension configured to operably mate with the one interface.

25. The assembly of claim 24 further comprising a support member configured to support the belt drive extension.

26. The assembly of claim 25 further comprising a belt drive wheel operably coupled to the belt drive extension.

27. A method for powering a belt drive from a chainsaw, the method comprising:
providing a chainsaw motor having a chainsaw motor drive;
encompassing the motor drive to engage recesses of the drive with an adapter; and
engaging the adapter with a belt drive.

28. The method of claim 27 further comprising supporting a portion of the belt drive with a support member.

29. The method of claim 27 further comprising coupling the belt drive to the adapter.

30. The method of claim 29 wherein the coupling is between two complimentary interfaces.

31. A chainsaw and accessory assembly, the assembly comprising a chainsaw motor operably coupled to a chainsaw accessory by a belt drive.

32. The assembly of claim 31 wherein the belt drive is adapted to the chainsaw motor chain drive.

33. The assembly of claim 31 wherein the belt drive is operably engaged with a pump assembly.

34. The assembly of claim 31 further comprising adjustable members extending between the motor drive and the accessary.

35. The assembly of claim 31 further comprising a belt extending between the motor drive and the accessory drive.

36. The assembly of claim 35 wherein the belt defines ribs.
